(19) United States
(12) Patent Application Publication
(10) Pub. No.: US 2010/0110855 A1
(43) Pub. Date: May 6, 2010

(54) ROBUST POSITION DETECTION FOR INCREMENTAL RECORDING

(75) Inventors: Davy Witter, Leuven (BE); Lofti Abkari, Leuven (BE); Wim Felix Maria De Kimpe, Zele (BE); Stefan Mathieu Alfons Vaes, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,480

(22) PCT Filed: Dec. 15, 2005
(86) PCT No.: PCT/IB2005/054263

§ 371 Date: Jun. 12, 2007

(30) Foreign Application Priority Data
Dec. 20, 2004 (EP) 04106716.6
Feb. 23, 2005 (EP) 05101352.2

(51) Int. Cl. G11B 15/04

(52) U.S. Cl. 369/53.24; G9B/15.006

(57) ABSTRACT

Method for accurately determining the link position for appending new recordings on an optical disc, where address information extracted from the HF data of a previous recording is used in conjunction with position information derived from the pre-groove to determine the link position for the new recording. The pre-groove position information may be derived from the phase of the pre-groove wobble, and the HF data address may be flywheeled to provide a more robust system. The drive may store and update a record table with the begin and end addresses of contiguous previously recorded area, the stored information being used in conjunction with position information derived from the pre-groove to determine the link position for the new recording.

The present invention relates generally to recording data on optical discs, and more particularly to determining the position for a new recording on an optical disc, which includes previously recorded data.

Recordable optical discs generally include a pre-formed spiral groove on the disc called a pre-groove that is used to guide the radiation beam used by a recording device to record data onto the disc. The pre-groove is pre-formed on the disc with a sinusoidal wobble of a certain frequency, which is used by the recording device to control the speed of rotation of the disc and to determine the frequency of a clock used for recording, which determines the bit-rate of the recording.

Additional information may also be included in the pre-groove, used for navigation for reading and recording the disc, and retrieving information about the disc media type and other data. This additional information, including address or position information for navigation, may be encoded on the disc by pre-forming the re-groove with a modulated wobble frequency using FM modulation (for CD-R and CD-RW discs) or phase modulation (for DVD+R and DVD+RW discs). For DVD-R and DVD-RW discs, the pre-groove wobble frequency is not modulated and the address/position information is provided by using so-called pre-groove Land Pre-Pits (LPP's). The LPP's are pits that are pre-formed on the land portions between the spiral grooves of the pre-groove.

When a first recording is made on an empty disc, this pre-groove addressing information is used to position the radiation beam of the recording device for making the recording. When a subsequent recording is made, it is desirable to determine a “link position” on the spiral pre-groove at the end of the previously recorded data at which to begin the next data recording.

A problem can arise when making such a subsequent recording on DVD-R and DVD-RW discs. When a recording has already been made on a such a disc, the previously recorded data (called the high frequency (HF) data or EFM+ data) adjacent to the position on the disc where the new recording is to be made can interfere with detection of the LPP's due to modulation and cross-talk of the push-pull signal used to read data from the disc. The LPP's are used by the recording device for navigation so that the recording device can accurately determine where its radiation beam is positioned on the disc. When the LPP's cannot be detected, the recording device cannot reliably identify its current position on the disc and thus cannot accurately determine the link position where the new recording should begin. This makes it difficult to accurately position a new data recording.

EP 1 227 491 describes a recording apparatus capable of recording data even when the apparatus experiences difficulties reading the LPP's. The apparatus comprises an LPP detection circuit and generates a block signal each time an LPP is detected. The apparatus also includes a phase locked loop that synchronizes a reference clock signal to the output of the LPP detection circuit, so that block signals can be generated even when detection of an LPP is missed. However, detection of sufficient LPP's is still required in order to reliably generate the block signals.

An object of the invention is to provide a method for determining the position for a new recording while avoiding reliance on the LLP address information, while maintaining accurate alignment between the position of the new recording and the pre-embossed address/position information encoded in the LPP's.

According to the invention, the position is determined for a new recording on an optical disc that includes previously recorded data, by reading the previously recorded data and determining the position for the new recording based on the previously recorded data. The recorded HF (user) data contains the same kind of address information as the LPP's at that same location, and this address information may be extracted from the previously recorded HF data and used for positioning the radiation beam for making the new recording. The position for the new recording may be based on address information extracted from the previously recorded data including at least a sector number, frame number and byte number derived from a counter, and additionally based on a bit number derived from a counter. Flywheel logic may be used for one or more of the sector number, frame number, byte number, and/or bit number.

When the HF data rather than the LPP address information is used to determine the link position, there is no direct link between the start position of the appended recording and the LPP address information. This means that no alignment can be guaranteed between the recorded data and the pre-groove on the disc. Furthermore, because the start position of each subsequent recording relies on the position of the previous recording, any error in positioning the recordings will be cumulative.

In order to avoid accumulation of error in the positioning of a series of recordings, the position for the new recording is preferably based in part on pre-groove information. This can be achieved by using the pre-groove position information in conjunction with the address information from the HF data to accurately determine the link position for appending new recordings while avoiding reliance on the LPP position information. The position for the new recording may be based on a coarse position and a fine position, where the previously recorded HF data is used to determine a coarse position and the pre-groove information is used to determine a fine position.

The phase of the pre-groove wobble is preferably used to determine the fine position for the new recording. The phase of the pre-groove wobble can be retrieved accurately from the disc, even from parts of the disc that have been recorded with HF data. This phase information can then be taken into account to accurately determine the start position for the next recording. The address information extracted from the previously recorded data may be compared to the pre-groove wobble phase information to determine a deviation between the address information from the previously recorded HF data and the pre-groove information. This deviation represents error in the positioning of the previously recorded HF data, and the deviation may be used to adjust the coarse position to obtain the fine position. Alternatively, the previously recorded data may be used to determine a coarse position at a predetermined position (e.g. approximately a half wobble period) in front of the desired position for the new recording, and the pre-groove wobble phase information then used to define the fine position for the new recording.

The invention also includes a method for making a new recording on an optical disc, including the steps of determining a desired start position for the new recording, determining the current position on the disc, comparing the current position with the desired start position, and positioning the new recording based on the comparison, where the current position on the disc is determined according to the methods described above (HF data positioning method).

The invention is also related to a method of making a recording on an optical disc according to the pre-amble of claim 11. The method comprises a checking step for determining whether previously recorded used data immediately precedes the desired start position and positioning the new recording according to HF-data positioning method if previously recorded user data is found. If no previously recorded user data is found, the positioning is based on track address information, extracted from the track modulation (LPP-address positioning). The said method allows reliable recording of both empty discs and partially recorded discs.

Further methods of making a recording on an optical disc can are defined in claims 12 and 13. The procedure of checking whether prior user data has been recorded on disc in the region immediately preceding the desired start position is a time consuming to execute and reduces the overall recording performance of the recording apparatus. According to the said methods, information regarding the begin and end addresses of recorded disc areas comprising contiguous previously recorded user data is memorized and the desired start and end positions for the new recording are determined. In a verification step it is verified if the desired start position matches any of the end addresses of the recorded disk areas or if the desired end position matches any of the begin addresses of the recorded disk areas. If a match is found, the new recording is positioned directly according to the HF-data positioning method without checking for prior user data. If no match is found a check is performed whether previously recorded data immediately precedes or follows the desired start or end position and a positioning method is chosen accordingly. The procedure of checking whether prior user data has been recorded on disc in the region immediately preceding the desired start position is a time consuming to execute and reduces the overall recording performance of the recording apparatus. Therefore by using the verification step, the use of the checking procedure may be avoided in most cases, as normally most new recording are appended immediately after a previous recording.

After a new recording is made, the memorized information regarding the start and end addresses of recorded disk areas may be updated as defined in claim 15. By maintaining updated information, the probability that a match is found in the verification step is increased; therefore the overall recording performance is increased.

The invention also includes a recording device for recording an optical disc, the device including a radiation beam for reading data previously recorded on the disc and for making a new recording on the disc, means for extracting address information from the previously recorded data, and means for determining a position for the new recording based on the extracted address information. The means for extracting address information preferably extracts at least a sector number and frame number from the previously recorded data, and the means for determining a position for the new recording preferably includes counters for determining byte and bit numbers of the position for the new recording, and flywheel logic for the sector number, frame number, byte number, and/or bit number.

The recording device preferably includes means for reading pre-groove position information, and the means for determining the position for the new recording preferably determines a coarse position based on the address information extracted from the previously recorded data, and a fine position based on the pre-groove position information. The means for determining the position for the new recording preferably uses the phase of the pre-groove wobble to determine the fine position.

In an embodiment the means for determining the position for the new recording compares the address information extracted from the previously recorded data to the pre-groove position information to determine a deviation between the address information and the pre-groove information for adjusting the coarse position to obtain the fine position. Alternatively, the means for determining the position for the new recording determines a coarse position at a predetermined position (e.g. approximately a half wobble period) in front of the desired position for the new recording.

An advantageous embodiment of the recording device is defined in claim 16. The recording device also comprises means for checking whether previously recorded used data immediately precedes the desired start position and selection means for selecting the HF-data positioning method for positioning the new recording if previously recorded user data is found. If no previously recorded user data is found, the selection means select the LPP-address positioning method. The said recording device reliably records both empty and partially recorded discs.

Further embodiments of the recording device are defined in claims 17 and 18. The device has means for memorizing information regarding the begin and end addresses of recorded disc areas comprising contiguous previously recorded user data and means for determining the desired start and end positions for the new recording. The said device also has verification means for verifying if the desired start position matches any of the end addresses of the recorded disk areas or if the desired end position matches any of the begin addresses of the recorded disk areas. The said device also has second selection means, for selecting the HF-positioning method if a match is found. If no match is found the selection means select the checking means and the selection means in order to select a positioning method.

In a still further embodiment, after a new recording is made, the memorized information regarding the start and end addresses of recorded disk areas is updated according to claim 15. By maintaining updated information, the probability that a match is found in the verification step is increased; therefore the overall recording performance is increased.

The invention makes it unnecessary to rely on reading the LPP address information in areas of the disc that have been previously recorded when appending new recordings, while maintaining accurate alignment between the pre-groove and the new recorded data. The invention thus avoids the reliability problems in reading the LPP information from recorded portions of the disc by basing the start position of a new recording on previously recorded HF data rather than LPP information. An accurate relation between new HF data recording and the pre-groove can be further ensured by using the previously recorded HF data in conjunction with pre-groove position information.

These and other aspects of the invention will be apparent from and elucidated with reference to the embodiment(s) described hereinafter.

The features and advantages of the invention will be appreciated upon reference to the following drawings, in which:

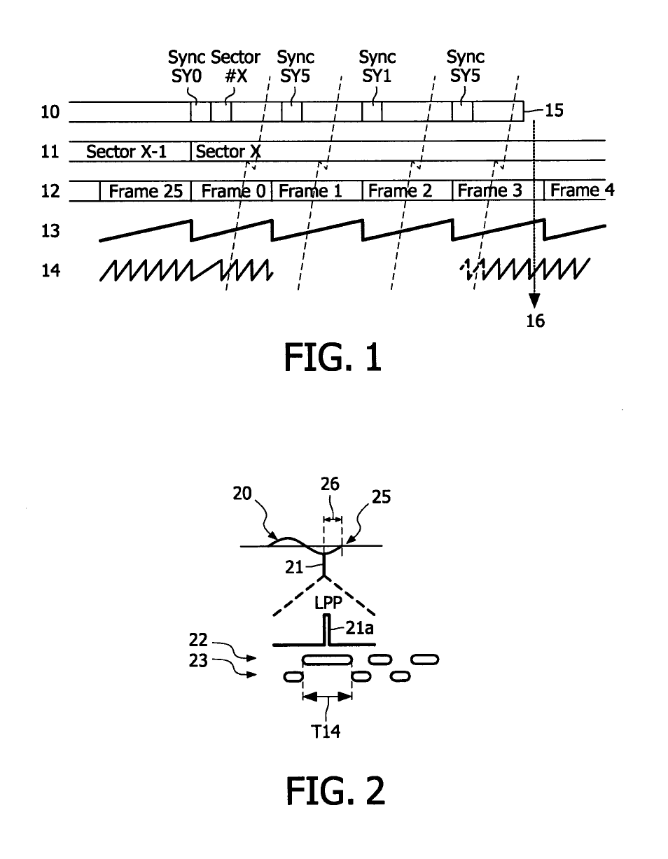

FIG. 1 is a schematic diagram of a flywheeled address generated from HF data.

FIG. 2 is a schematic diagram showing relative positions of the land pre-pits and frame sync bytes of the HF data in relation to the pre-groove wobble.

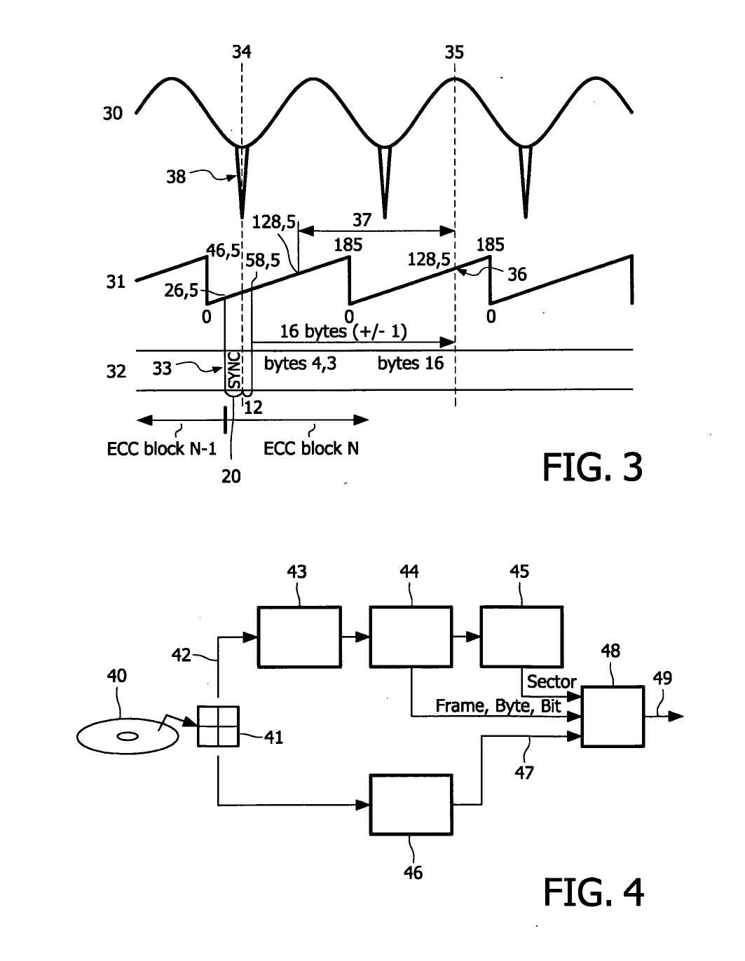

FIG. 3 is a schematic diagram showing a method for using the phase of the pre-groove wobble for determining the start position for appending a recording.

FIG. 4 is a block diagram of a circuit of a recording device for determining the start position for appending a recording.

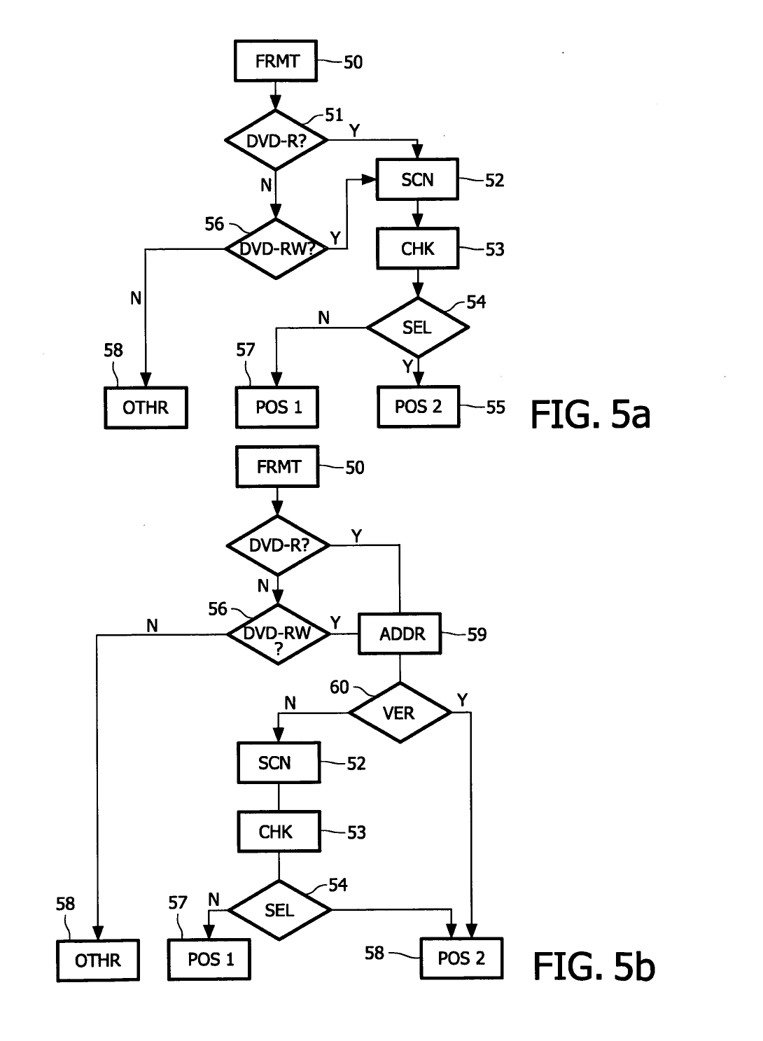

FIG. 5a and b are two flowcharts for selecting a method for positioning a new recording, characterizing the two embodiments disclosed herein.

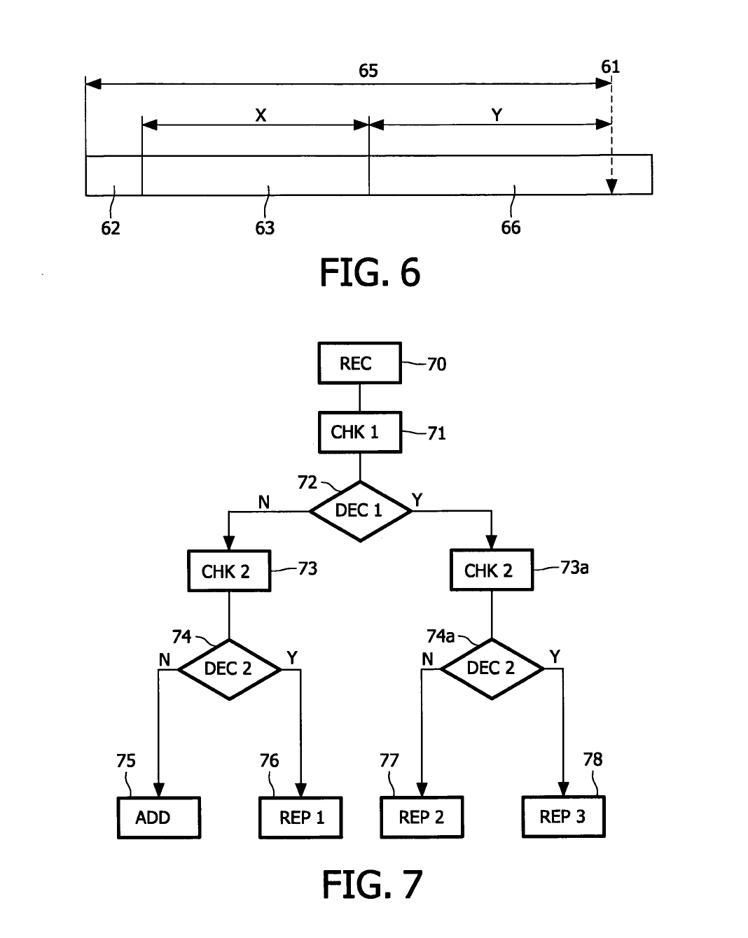

FIG. 6 is a schematic diagram of portions of a disc preceding a desired start position for a new recording.

FIG. 7 is a schematic diagram showing the method of updating the memorized information relating to begin and end addresses of recorded disk areas comprising contiguous previously written user data.

The HF EFM+ data recorded on a DVD disc can be used to derive address information that indicates the position on disc at which the HF data is located. The format for this address information is defined by the DVD specifications, and generally comprises the following elements (although it should be noted that the invention can be applied to address information having different formats):

(a) a sector number, located in the header field of every DVD sector;
(b) a sync frame number within the sector, in the range 0-25;
(c) a byte number within the sync frame, usually in the range 0-91 (byte 91 is the EFM+ sync byte, although this numbering is arbitrary and other numbering could be used); and
(d) a bit number within the byte, in the range 0-15 for data bytes and in the range 0-31 for EFM+ sync bytes.

This address information can be extracted from the recorded HF data by a recording device as it scans the disc. Thus, the HF data that was previously recorded on a disc may be used instead of the pre-groove address information to determine the current position on the disc being scanned by the recording device. In order to make a new recording at the end of a previous recording, the recording device first determines where the previous recording ends. This information may be stored in the memory of the recording device (if the recording device made the previous recording), or may be available from the temporary table of contents recorded in the lead-in area of the disc, or can be detected by scanning the disc and locating the end of the previously recorded HF data (for instance by checking the amplitude of the read signal). The recording device then determines the link position where the new recording should start.

The address data derived from the previous recording can be used to determine when the desired start position is reached. Each sector of the HF data includes a sector number that can be extracted from the HF data. Each sector is divided in 26 equally sized frames, and each frame starts with a sync byte. There are eight different types of frame sync bytes (SY0-SY7), and the frame number can be derived by detecting the current type together with the previous/following type. Each frame contains 91 bytes (of 8 bits each) and the sync byte. The byte number and bit number offset with a frame is determined using counters. These address counters preferably count at the speed of the HF data (EFM+) bit rate, which may be determined by a phase locked loop (PLL) locked to the HF data bits in the HF data stream. To make the system more robust, one or more elements of the address are preferably protected by flywheel logic, which continues to increment the address at the HF data bit rate even when the bits from the HF data cease being read. This ensures the address counters continue incrementing in case the HF data signal is temporary unreadable (e.g. due to a defect in the disc or in the previous data recording) or if the desired link position of the new recording is not directly after the end of the previous recording, but a small unrecorded gap is left in between the two recordings.

FIG. 1 illustrates an example of a flywheeled address generated from HF data. The HF data address information 10 extracted from the previous recording includes sync bytes SY0, SY5, SY1, and SY5 for each frame in sector X at the end of the recording. The sector number flywheel 11 thus indicates sector X, and the frame number flywheel 12 increments the frame number coinciding with each sync byte. The byte number flywheel 13 increments the byte number within each frame and the bit number flywheel 14 increments the bit number within each byte. When the flywheeled address equals the desired start position 15, the new recording starts. In FIG. 1 this is indicated by the dashed arrow 16 when the flywheeled address equals sector x, frame 3, byte 90, bit 3.

It should be noted that the accuracy with which the radiation beam of the recording device can be positioned at a particular location on the disc is finite. The actual position of a recording relative to the previous recording and/or relative to the pre-groove wobble will always be of the order of magnitude of a few channel bits, say N bits. If the start position for a recording is determined relative to address information derived from the pre-groove, the start position for each new recording will always start from the same reference (i.e. the pre-groove), and the error in positioning each new recording will not be accumulated.

If only the HF data address information from the previous recording is used to determine the start position for each new recording, then the error in positioning each recording will include the error in positioning each prior recording. For example, the second recording start position will have a worst case total error of 2xN, the third will be 3xN and so on. To avoid this, use may be made of address/position information that is independent of the previous recordings, such as address/position information decoded from the pre-groove. In this way the HF address data read from the previous recording can be used to make a coarse determination of the position for the new recording, and the position information decoded from the pre-groove can be used to make a fine determination of the position for the new recording.

One method to accomplish this is to measure the deviation between the position of the previously recorded HF data and the pre-groove LPP's. The relationship between the recorded HF data and the pre-groove LPP's is illustrated in FIG. 2, which shows the relative positions of the sinusoidal variation of the pre-groove wobble 20 and the position of LPP 21. An enlarged picture of the LPP (shown as LPP 21a) and the T14 pit of the frame sync byte of the HF data 22 is also shown. Alternatively, a T14 land of the sync byte of the HF data is shown as 23. The T14 pit/land is a pit or land that comprises a run of 14 identical bits (zeros or ones) and occurs only in frame sync bytes in the recorded HF data. As can be seen in FIG. 2, the pre-groove LPP's and the sync bytes of the HF data are aligned so that the LPP 21/21a coincides with the middle of the T14 land/pit. This is a requirement defined by the DVD-R(W) specifications.

Thus, any deviation between the frame sync bytes in the recorded HF data and the pre-groove LPP's will represent error in the position of the previously recorded HF data. This deviation can be used to correct the coarse position for the new recording to obtain a fine position for the new recording, by adding or subtracting the amount of the deviation from the coarse position. This will remove the effect of any error in the position of the previous recording and reset the start position for the new recording relative to the pre-groove, to achieve as accurate position as would be achieved if the position for the new recording was based solely on we-groove information, and prevent an accumulation of error. The recording device can read the previously recorded HF data over a period of time and compare the frame sync byte positions with the LPP positions to determine an average deviation. Although some of the LPP's may not be readable due to interference from the previously recorded HF data, performing the above comparison over a large portion of the HF data will minimize this problem.

Alternatively, instead of using the LPP's, the phase of the pre-groove wobble may be used to determine the fine position for the new recording. This has the advantage that the wobble phase is position information of a type that can be reliably detected even in portions of the disc that have already been recorded with HF data. Referring again to FIG. 2, it can be seen that the pre-groove wobble 20 and the LPP 21/21a are aligned so that the LPP 21/21a coincides with a negative peak of the wobble signal 20, at a phase position 90° from the zero-crossing 25 of the wobble signal to an accuracy of plus or minus 10°. Because the middle of the T14 land/pit is aligned with the LPP 21/21a, this means that the middle of the T14 land/pit falls at a negative peak of the wobble, at a phase position 90° plus or minus 10°.

The pre-groove wobble period corresponds in length to 186 bits at the HF data bit rate, so the desired phase relationship between the middle of the T14 land/pit and the pre-groove wobble can be expressed in bits in relation to a feature, such as a zero-crossing, of the pre-groove wobble. Taking the above into account, the middle of the T14 land/pit should be between)[(90°−10°/360°×186 bits] and [(90°+10°/360°×186 bits] bits away from a zero-crossing of the pre-groove wobble, i.e. between 41 bits and 51 bits from a zero-crossing. When the N bit error in the positioning of the previous recording discussed above is taken into account, the middle of the T14 land/pit is between 41−N bits and 51+N bits away from a zero-crossing of the pre-groove wobble.

This relationship between the T14 land/pit position and the expected position of a zero-crossing of the pre-groove wobble can be used to determine any error in the position of the previously recorded HF data. Any deviation between the expected and the measured wobble phase at the moment a T14 pit/land is detected will represent error in the position of the previously recorded HF data, and this deviation can be used to correct the coarse position for the new recording to obtain a fine position for the new recording.

The recording device can read the previously recorded HF data over a period of time and measure the distance between the frame sync byte positions and the zero-crossing positions of the wobble phase. Any deviation between the measured distance and the expected distance can be used, similarly to the previous method, as a correction to adjust the coarse position to obtain the fine position, by adding or subtracting the amount of the deviation from the coarse position.

Another alternative enables the above mechanism to be implemented in a different way. The start position for the new recording may be determined based on the HF data of the previous recording as described previously, but a start address is chosen which is a half wobble period in front of the actual desired start position. This is used as the coarse position. For example, for a DVD-R disc the start address would be calculated as 93 EFM+ bits before the actual desired start position. The phase of the pre-groove wobble is then used to determine a fine position, defining the exact location of the start position. Similarly to the above methods, the combination of coarse and fine positions will link the position of the recorded HF data to the pre-groove wobble phase and prevent an accumulation of error in the positioning of each HF data recording.

FIG. 3 shows an example of determining the link position at which to append a new recording according to this third alternative method. FIG. 3 shows the pre-groove wobble 30 with LPP's 38, and a phase count 31 indicating the phase of the pre-groove wobble. Phase count 31 may be generated by a phase-locked loop (PLL) locked to the wobble frequency and incrementing from zero to 185 bits over one period of the pre-groove wobble, i.e. incrementing at the bit rate of the HF data stream. The HF EFM+ data stream 32 includes a frame sync byte 33 at the beginning of ECC block N. The middle of the T14 pit/land of the sync byte is shown by dashed line 34. This mid point 34 falls at the point 20 bits from the most significant bit of the sync byte and 12 bits from the least significant bit of the sync byte, as indicated in FIG. 3. As noted previously, the mid point 34 coincides with a peak of the pre-groove wobble waveform (shown as a positive peak in FIG. 3), which also coincides with the first LPP 38 of the frame.

In order to position the radiation beam of the recording device for making the new recording, a desired start position 35 for the new recording is generated. The example shown in FIG. 3 is based on the requirements in the DVD-R(W) specification for determining the desired start position. The DVD-R(W) specification requires the linking point between two recordings to be positioned in the first frame of the first sector of an ECC block, after the sixteenth byte (plus or minus one byte) after the sync byte of this frame. Thus, the start address for a new recording in ECC block N according to this requirement is sector X, frame 0, byte 16, bit 0. This address could be determined solely by relying on the address information in the previously recorded HF data. However, in one embodiment of the invention the phase count 31 may be used to provide a more precise determination of the start position.

In this embodiment, the HF data address is used as a coarse position indication and the phase count 31 is used to more precisely indicate the link position 35 for starting the new recording. In FIG. 3, the link position 35 is shown at a position sixteen bytes after the sync byte 33. In the example shown in FIG. 3, the end of the sync byte coincides with a phase count 31 of 58.5. Sixteen bytes (i.e. 256 bits) after this position the phase count 31 equals 128.5 (i.e. 58.5+256−186) at point 36 shown in FIG. 3. Thus, the desired link position 35 coincides with a phase count value of 128.5, and the phase count can be used to more precisely determine the current position for starting the new recording.

The start address for a new recording in ECC block N can be expressed as sector X, frame 0, byte Y, bit Z, phase count 128, where the sector, frame, byte, and bit values are determined based on the HF data address from the previous recording and represents the coarse positioning. The byte value Y and bit value Z may vary. In the example shown in FIG. 3, the value Y is preferably between 5 and 15 in order to result in a coarse position within one wobble period of the desired link position 35 (i.e. within range 37 shown in FIG. 3). It is preferable to choose value Y to fall in the middle of this range.

FIG. 4 shows a block diagram of a circuit of a recording device for determining the start position for appending a recording. The recording device scans a disc 40 and detector and read circuit 41 generates a bit stream 42 from the previously recorded HF data. Bit stream 42 is input into an HF bit detection circuit 43 and then to an EFM+ demodulator circuit 44. The EFM+ demodulator circuit 44 demodulates the HF data and outputs the current frame number and byte and bit position within the frame to address compare circuit 48. A PI frame decoder 45 extracts the physical sector number from the demodulated HF data and outputs the current sector number to address compare circuit 48. A wobble phase locked loop 46 receives a push/pull signal from the detector and read circuit 41, representing the wobbling of the pre-groove, and outputs a phase count signal 47 to address compare circuit 48. Address compare circuit 48 receives the current sector number, frame number, byte and bit position within the frame, and the current phase count signal 47, which together describe the current position of the radiation beam of the recording device. Circuit 48 compares the current position with the desired link position and when they match, circuit 48 outputs a signal 49 to trigger the start of the new recording. The circuit shown in FIG. 4 is illustrative only, and may be implemented in different configurations and using hardware, firmware or software or a combination, using techniques well know in the art.

The above description relates to appending new recordings onto a disc in which the link position is determined based at least in part on the address information located in the previous recording. When a new recording is to be made on a blank disc or a blank part of the disc with no previous recorded data, it is still necessary to use a method of determining the start position that does not rely on having a previous recording. Such a recording may, for example, rely solely on the LPP information in the pre-groove to determine the start position for the new recording. FIG. 5 is a flowchart illustrating an example of a method for making a new recording on an unknown disc.

In one embodiment, the sequence shown in FIG. 5a is executed each time a new recording is made on a disc. The process begins with a disc-format recognition function 50 (FRMT) that determines which type of disc has been inserted in the recording device. If the disc is not a DVD-R format disc, in step 52 (DVD-RW?) it is determined if the disc is a DVD-RW format disc. If the disc is neither a DVD-R disc nor a DVD-RW disc, in step 58 (OTHR), a linking method specific to the disc type is selected. If the disc is either a DVD-RW format disc or a DVD-R format disc the method proceeds to the scan function 52 (SCN). The scan function 52 (SCN) scans the disc for the presence of recorded HF (user) data at the desired start position of the new recording. An area of the disc of scan period Z, located before the desired start position for the new recording is scanned (read back) by the recording device, and the presence of HF data recorded on the disc and the locations at which HF data is recorded in this area is determined. The presence of HF data can be detected by various methods, for example by measuring the amplitude of the read signal.

A decision function 53 based on the output of the scan function (SEL) selects to position the new recording either via the HF-linking method (determining the link position based at least in part on address information in previously recorded HF data) or via the LPP-linking method (determining the link position based at based solely on the LPP in the pre-groove.) If previously recorded HF data is found, the HF-linking method is performed in step 55 (POS1), and if not, the default LPP-linking method is performed in step 57 (POS2).

In an advantageous embodiment, the method steps shown in FIG. 5b are performed every time a new recording is made to the disc. Herein, a record table comprising the start and end addresses of each recorded disc area containing contiguous previously recorded user (HF) data is maintained in the memory of the drive. The method begins with a disc-format recognition function (FRMT) 50 that determines which type of disc has been inserted in the recording device. If the disc is not a DVD-R disc, step 56 (DVD-RW?) checks whether the disk is a DVD-RW disk. If the disc is neither a DVD-R disc nor a DVD-RW disc, in step 58 (OTHR), a linking method specific to the disc type is selected. If the disc is either a DVD-R disc or a DVD-RW disk, the method proceeds to address verification function 59 (ADDR). The address verification function 59 determines the desired start and end positions of the new recording and verifies whether the desired start position matches any of the end addresses of the entries stored in the memorized record table or whether the desired end position matches any of the begin addresses of the entries stored in the memorized record table. The method proceeds with a decision stem 60 (VER). If a match is found in any of the two verifications, the method proceeds to the positioning step 55 (POS2), where the new recording is positioned via the HF linking method and the memorized record table is updated. Returning to the decision step 60 (VER), if no match is found in the two verifications, the method proceeds to scan function 52 (SCN), which checks the disc for the presence of previously recorded user data immediately preceding the desired start position of the new recording or immediately following the desired end position. A decision function 54 (SEL) based on the output of the scan function selects the positioning method: the HF-linking method (POS1), followed by an update of the memorized record table in step 55, if previously recorded user-data is found or the LPP-linking method, followed by an update of the memorized record table in step 57.

The LPP address information can be read from a recorded disc more reliably for DVD-RW type discs than for DVD-R type discs. Thus, for DVD-RW discs the methods of FIG. 5a or FIG. 5b provide a means for the user to decide whether to only use the LPP-linking method or whether to attempt to use the HF-linking method. This choice can be made, for example, by setting or not setting a ‘HF-linking preferred’ flag in the recording device. If the flag is set off, then if in the decision step 56 (DVD-RW?) a DVD-RW disc was founds, the method proceeds to step 57, positioning according to LPP method (POS1).

Two criteria are preferably used in the selection step 54 (SEL) to select whether the HF-linking method should be used: a minimum period X of HF data should be present before the desired start position for the new recording, and the distance between the end of the HF data (of minimum period X) and the desired start position should be smaller than period Y. If the Y is negative, indicating that HF data is present past the desired start position, then Y is considered to be zero. For the methods as claimed in claims 17 and 18 and described in FIG. 5b, in deciding whether HF data immediately follows the desired end address, a minimum period X of HF data should be present after the desired end position for the new recording, and the distance between the begin of the HF data (of minimum period X) and the desired end position should be smaller than period Y. If the Y is negative, indicating that HF data is present before the desired start position, then Y is considered to be zero.

The period X is preferably chosen as the maximum time required for the HF data flywheels to go into lock, so that a period of HF data at least X long will permit the HF data flywheel functions to operate properly. The period Y is preferably chosen to be less than the maximum time required for the LPP data flywheels to go into lock. The total scan period Z is preferably greater than the sum of periods X and Y, as shown schematically in FIG. 6. In FIG. 6, the desired start position 61 on the disc is preceded by blank portion 62, a recorded portion 63 containing HF data, and another blank portion 64. According to the above criteria, the HF-linking method should be used if the recorded portion 63 is greater than period X and the blank portion 64 is less than period Y. In addition, the scan period 65 should be greater than periods 63 and 64 combined.

FIG. 7 represents a schematic diagram of the method to update the memorized record table containing the start and end addresses of recorded disc areas comprising contiguous previously recorded user data. After the step of recording a new recording on the disc (REC) 70 is finished, the method proceeds to the first check function 71 (CHK1), which checks whether the begin address of the new recording matches any of the end address of the entries in the record table. This is followed by a first decision function 72 (DEC1). If no match is found, a second check function 73 (CHK2) is performed, which checks whether the end address of the new recording matches any of the begin addresses of the entries of the record table. This is followed by a second decision function 74 (DEC2). If no match is found, meaning that the new recording is written in an empty disc area, in the update step 75 (ADD) the start and end addresses of the new recording are added as a new entry in the memorized record table. If a match was found in the second decision step 74 (DEC2), meaning that the new recording is appended directly before a previously recorded area, in the update step 76 (REP1) the begin address of the matching entry of the record table is replaced with the begin address of the new recording. Returning to the first decision 72 (DEC1), if no match was found, the second check function 73a (CHK2) is performed, which checks whether the end address of the new recording matches any of the begin addresses of the entries of the record table. This is followed by a second decision function 74a (DEC2). If no match was found in step 74a, meaning that the new recording is appended directly after a previously recorded area, in the update step 78 (REP2) the end address of the matching entry in the record table is replaced with the end address of the new recording. If a match was found in decision in step 74a (DEC2), meaning that the new recording creates a single contiguous region encompassing two previously written areas, the update step 78 (REP3) is performed. In the update step 78 (REP3), both matching entries are modified as follows: the second matching entry (having a begin address matching the end address of the new recording) is deleted and the end address of the first matching entry (having an end address matching the begin address of the new recording) is replaced with the end address of the second entry.

This invention can be applied in any DVD-R or DVD-RW optical recorder, and may also be applied in other types of recorders, and for recording data, audio, video, or other types of information. The invention makes it unnecessary to rely on reading the LPP address information in areas of the disc that have been previously recorded when appending new recordings. This thus avoids the reliability problems in reading the LPP information from recorded portions of the disc by basing the start position of a new recording on previously recorded HF data rather than LPP information. An accurate relation between new HF data recording and the pre-groove can be further ensured by using the previously recorded HF data in conjunction with pre-groove position information. Any error in the positioning of the previously recorded HF data can be removed by setting the start position for the new recording relative to the pre-groove, preferably using the phase of the pre-groove wobble for this purpose. This prevents an accumulation of error with each new recording.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. A method for determining the position for a new recording on an optical disc that includes previously recorded data, the method comprising reading the previously recorded data and determining the position for the new recording based on the previously recorded data.

2. The method as claimed in claim 1, characterized in that the position is based on address information extracted from the previously recorded data including at least a sector number and frame number.

3. The method as claimed in claim 2, characterized in that the position is additionally based on byte and bit numbers derived from counters.

4. The method as claimed in claim 2 or claim 3, characterized in that one or more of the sector number, frame number, byte number, and/or bit number is flywheeled.

5. The method as claimed in any one of the preceding claims, characterized in that the position for the new recording is based in part on pre-groove information, the previously recorded data being used to determine a coarse position and the pre-groove information being used to determine a fine position, the position for the new recording being based on the coarse position and the fine position.

6. The method as claimed in claim 5, characterized in that the pre-groove information used to determine the fine position comprises the phase of the pre-groove wobble.

7. The method as claimed in claim 5 or claim 6, characterized in that the address information extracted from the previously recorded data is compared to the pre-groove information to determine a deviation between the address information and the pre-groove information, and the deviation is used to adjust the coarse position to obtain the fine position.

8. The method as claimed in claim 5 or claim 6, characterized in that the previously recorded data is used to determine a coarse position at a predetermined position in front of the desired position for the new recording, and the pre-groove information is used to define the fine position at a point after the predetermined position.

9. The method as claimed in claim 8, characterized in that the predetermined position is approximately a half wobble period in front of the desired position for the new recording.

10. A method for making a new recording on an optical disc, comprising:
determining a desired start position for the new recording;
locating a current position on the disc;
a positioning step, comprising comparing the current position with the desired start position; and positioning the new recording based on the comparison, characterized in that the current position on the disc is determined according to the method as claimed in any one of the preceding claims.

11. A method for making a new recording on an optical disc, the optical disc comprising a track for recording user data along the track, the track being provided with a track modulation, the track modulation comprising track address information for locating a position along the track, the method comprising:
determining a desired start position for the new recording;
a first positioning method for positioning the new recording on the disc, comprising determining a position for the new recording using the track address information from the track modulation,
the method for making a new recording further characterized by
a second positioning method for positioning the new recording on the disc, comprising comparing a current position with the desired start position and positioning the new recording based on the comparison wherein the current position on the disc being determined according to the method in any one of claims 1-9;
a checking step, for determining whether previously recorded user data immediately precedes the desired start position;
positioning the new recording on the disc according to the first positioning method if no previously recorded user data is found in the checking step and according to the second positioning method if previously recorded user data is found in the checking step.

12. A method for making a new recording on an optical disc, the optical disc comprising a track for recording user data along the track, the track being provided with a track modulation, the track modulation comprising track address information for locating a position along the track, the method comprising:
determining a desired start position for the new recording;
memorizing information related to end addresses of recorded disc areas comprising contiguously recorded user data;
extracting the end addresses of the recorded disc areas from the memorized information;
a first positioning method for positioning the new recording on the disc, comprising determining a position for the new recording using the track address information from the track modulation;
the method for making a new recording further characterized by
a second positioning method for positioning the new recording on the disc, comprising comparing a current position with the desired start position and positioning the new recording based on the comparison, wherein the current position on the disc being determined according to the method of any one of claims 1-9;
a verification step for determining if the desired start position matches any of the extracted end addresses of the recorded disc areas;
positioning the new recording according to the second positioning method, if a match is found in the verification step;
a checking step, for determining whether previously recorded user data immediately precedes the desired start position, if no match is found in the verification step;
positioning the new recording according to the second positioning method, if previously recorded user data is found in the checking step;
positioning the new recording according to the first positioning method, if no previously recorded user data is found in the checking step.

13. A method for making a new recording on an optical disc, the optical disc comprising a track for recording user data along the track, the track being provided with a track modulation, the track modulation comprising track address information for locating a position along the track, the method comprising:
determining a desired end position for the new recording;
memorizing information related to begin addresses of recorded disc areas comprising contiguously recorded user data;
extracting the begin addresses of the recorded disc areas from the memorized information;
a first positioning method for positioning the new recording on the disc, comprising determining a position for the new recording using the track address information from the track modulation;
the method for making a new recording further characterized by
a second positioning method for positioning the new recording on the disc, comprising comparing a current position with the desired start position and positioning the new recording based on the comparison, wherein the current position on the disc being determined according to the method of any one of claims 1-9;
a verification step for determining if the desired end position matches any of the extracted begin addresses of the recorded disc areas;
positioning the new recording according to the second positioning method, if a match is found in the verification step;
a checking step, for determining whether previously recorded user data immediately precedes the desired start position, if no match is found in the verification step;
positioning the new recording according to the second positioning method, if previously recorded user data is found in the checking step;
positioning the new recording according to the first positioning method, if no previously recorded user data is found in the checking step.

14. A method as claimed in claim 12 or 13, characterized by maintaining a record table comprising start and end addresses of the recorded disc areas comprising contiguously recorded user data.

15. A method as claimed in either 12, 13 or 14, characterized by an updating step after a new recording is made, the update step comprising:
replacing information relating to the end address of a recorded disc area if the end address matches the begin address of the new recording with information relating to the end address of the new recording;
replacing information relating to the begin address of a recorded disc area comprising previously recorded user data if the end address matches the begin address of the new recording with information relating to the begin address of the new recording;
replacing information relating to the end address of a first recorded disc area with the end address of a second recorded disc area and deleting the information relating to the second recorded disc area, if simultaneously the end address of the first recorded disc area matches the begin address of the new recording and the begin address of the second recorded disc area matches the end address of the new recording;
memorizing information relating to start and end addresses of the new recording, in all other cases.

16. A recording device for recording an optical disc, the device comprising:
a radiation beam for reading data previously recorded on the disc and for making a new recording on the disc;
means for determining a position for the new recording based on reading previously recorded user data.

17. A recording device for recording an optical disc, the device comprising:
a radiation beam for reading data previously recorded on the disc and for making a new recording on the disc;
means for extracting address information from the previously recorded data; and
means for determining a position for the new recording based on the extracted address information.

18. The recording device as claimed in claim 17, characterized in that the means for extracting address information extracts at least a sector number and frame number from the previously recorded data.

19. The recording device as claimed in claim 18, characterized in that the means for determining a position for the new recording comprises counters for determining byte and bit numbers of the position for the new recording.

20. The recording device as claimed in claim 18 or claim 19, characterized in that means for determining a position for the new recording comprises flywheel logic for one or more of the sector number, frame number, byte number, and/or bit number.

21. The recording device as claimed in any one of claims 16-20, characterized in that the device includes means for reading pre-groove position information, and characterized in that the means for determining the position for the new recording determines a coarse position based on the address information extracted from the previously recorded data, and a fine position based on the pre-groove position information.

22. The recording device as claimed in claim 21, characterized in that the means for determining the position for the new recording uses the phase of the pre-groove wobble to determine the fine position.

23. The recording device as claimed in claim 21 or claim 22, characterized in that the means for determining the position for the new recording compares the address information extracted from the previously recorded data to the pre-groove position information to determine a deviation between the address information and the pre-groove information for adjusting the coarse position to obtain the fine position.

24. The recording device as claimed in claim 21 or claim 22, characterized in that the means for determining the position for the new recording determines a coarse position at a predetermined position in front of the desired position for the new recording.

25. The recording device as claimed in claim 24, characterized in that the predetermined position is approximately a half wobble period in front of the desired position for the new recording.

26. The recording device as claimed in claim 25, characterized in that the predetermined position is approximately a half wobble period in front of the desired position for the new recording.

27. A recording device as claimed in any of the previous claims, comprising:
determination means for determining a desired start position for the new recording;
localization means for locating a current position on the disc;
comparison means, for comparing the current position with the desired start position, and
means for positioning the new recording based on the comparison.

28. A recording device as claimed in any of the claims 16-27 for making a new recording on an optical disc, the optical disc comprising a track for recording user data along the track, the track being provided with a track modulation, the track modulation comprising track address information for locating a position along the track, the recording device comprising:
determination means for determining a desired start position for a new recording;
first positioning means for positioning the new recording on the disc, comprising means for positioning the new recording based on the track address information from the track modulation;
the recording device further characterized in that it comprises:
localization means for locating a current position on the disc;
comparison means for comparing the current position with the desired start position;
second positioning means for positioning the new recording, comprising means for positioning the new recording based on comparing the current position with the desired start position;
checking means for checking whether previously recorded user data is preceding the desired start checking position;
selection means to select either the first positioning means if no previously recorded user data is found by the checking means or the second positioning means if previously recorded user data is found by the checking means.

29. A recording device as claimed in claim 28, characterized in that it comprises:
memorization means for memorizing information relating to end addresses of recorded disc areas comprising contiguously recorded user data;
extraction means for extracting end addresses of the recorded disc areas from the memorized information;
address comparison means for comparing if the desired start position matches the end address of any of the recorded disc areas;
second selection means for selecting the first positioning means if a match is found by the address-comparison means, or selecting the checking means and the selection means for positioning the new recording if no match is found by the address comparison means.

30. A recording device as claimed in claim 28, comprising:
determination means for determining a desired end position for the new recording;
recording device further characterized in that it comprises:
memorization means for memorizing information relating to begin addresses of recorded disc areas containing contiguously recorded user data;
extraction means for extracting the begin addresses of the recorded disc areas from memorized information;
address-comparison means for comparing if the desired end position matches any of the end addresses of the recorded disc areas;
second selection means for selecting the first positioning means if a match is found by the address-comparison means, or selecting the checking means and the selection means for positioning the new recording if no match is found by the address-comparison means.

31. A recording device as claimed in claim 29 or 30, characterized in that the memorized information relating to recorded disc areas comprises a record table comprising the start and end addresses of the previously recorded areas of the optical disc.

32. A recording device as claimed in any of the claim 28, 29 or 30, characterized in that the recording device comprises means for updating the stored information if a new recording is made, the said updating means comprising:
means for replacing the information relating to an end address of a recorded disc area with the information relating to the end address of the new recording, if the end address matches the begin address of the new recording;
means for replacing the information relating to an begin address of a recorded disc area with the information relating to the begin address of the new recording, if begin address matches the end address of the new recording;
means for replacing the information relating to an end address of a first recorded disc area with information relating to an end address of a second recorded disc area and deleting the information relating to the second recorded disc area, if the end address of the first recorded disc area matches the begin address of the new recording and the begin address of the second recorded disc area matches the end address of the new recording;
means for memorizing information relating to start and end addresses of the new recording, in all other cases.
